(19) United States
(12) Patent Application Publication
(10) Pub. No.: US 2009/0064525 A1
(43) Pub. Date: Mar. 12, 2009

(54) Structure tape rule hook

(76) Inventor: Michael Chen, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/898,377

(22) Filed: Sep. 12, 2007

(51) Int. Cl. G01B 3/10

(52) U.S. Cl. 33/758; 33/770

(57) ABSTRACT

An improved structure tape rule hook that provides a hook of the tape rule which has an attractive component. The hook is a planar component bent vertically to thereby form a hook mounting element at its upper extent, and disposed on the hook mounting element are a plurality of elongated round holes and, furthermore, the other side is bent downward vertically to form a hook measuring element. The hook measuring element has a containment recess, which is die extruded, enabling the embedding of the attractive component in order to fix it onto the hook measuring element. As such when taking measurements the attractive component of the tape rule increases user convenience, thereby enhancing the practical value of the tape rule provided by the improved structure tape rule hook of the invention herein.

### BACKGROUND OF THE INVENTION

1) Field of the Invention

The present invention relates to an improved structure tape rule hook, specifically one in which the hook of the tape rule has an attractive component, the hook is a planar component bent vertically to thereby form a hook mounting element at its upper extent, and disposed on the hook mounting element are a plurality of elongated round holes and, furthermore, the other side is bent downward vertically to form a hook measuring element, said hook measuring element having a containment recess, which is die extruded, enabling the embedding of the attractive component in order to fix it onto the hook measuring element; as such, when taking measurements the attractive component of the tape rule increases user convenience, thereby enhancing the practical value of the tape rule provided by the improved structure tape rule hook of the invention herein.

2) Description of the Prior Art

With some prior art tape rule hook structures, during the measurement process, the hook must be secured at the starting point of the measurement, or two operating personnel work together to conduct the measurement task which, in actual utilization, results in considerable inconvenience; in another conventionally utilized technology, referring to FIG. 1, FIG. 2, and FIG. 3, the tape rule 10 has disposed at the frontmost extremity of its blade 11 a plurality of round holes 12; additionally, the conventional hook 3 is a planar component bent vertically to thereby form a hook mounting element 31 at its upper extent, and disposed through the hook mounting element 31 are a plurality of elongated round holes 32 and, furthermore, the other side is bent downward vertically to form a hook measuring element 33, said hook measuring element 33 having disposed through it a plurality of mortise holes 35 for the embedding of an equivalent quantity of magnetically attractive components 34, the circumferential edges of the attractive components 34 have a beveled design, enabling the attractive components 34 to protrude slightly from the hook measuring element 33, their rear edges situated evenly with hook measuring element 33; the hook 3 also consists of a plurality of rivets 2 that are inserted through the elongated round holes 32 of the hook mounting element 31 as well as the round holes 12 of the blade 11 which are then compressively fastened into place, thereby enabling the conjoinment of the hook 3 to the blade 11; however, since the attractive components 34, are embedded in the mortise holes 35, during the utilization process, the hook 3 is subjected to frequent impact, resulting in the dislodging of the attractive components 34 which is a serious drawback, and how to further convenience utilization during tape rule measurement tasks is a problem, the solution of which has been long awaited by the industry.

### SUMMARY OF THE INVENTION

In view of the shortcomings of the prior art tape rule that need to be surmounted, the inventor of the invention herein conducted intensive research to effect improvement, culminating in the development of the improved structure tape rule hook of the present invention, which definitely remedies the drawbacks of the prior art products.

Therefore, the primary objective of the invention herein is to provide an improved structure tape rule hook structure, wherein an attractive component is embedded in the lower extent at the front end of the tape rule, such that when measurements are taken, the attractive components of the hook enable the conducting of the measurement task operation by a single person, the improved structure of the invention herein thereby increasing utilization convenience.

To enable a further understanding by the examination committee of the unique features of the invention herein, the detailed description of the preferred embodiments are preceded by the brief description of the drawings below, which illustrate the advantages of the present invention.

### BRIEF DESCRIPTION OF THE DRAWINGS

FIG. 1 is an exploded drawing of the prior art structure.

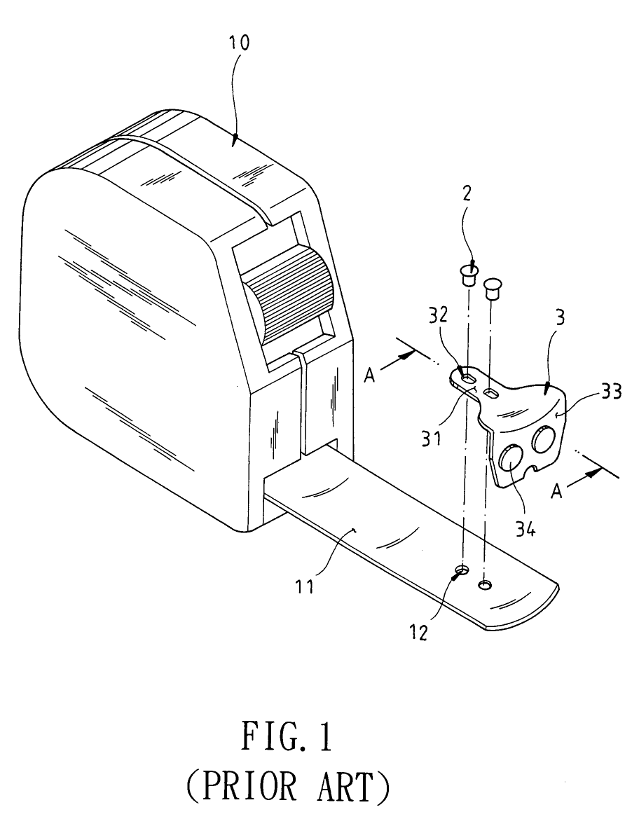

FIG. 2 is an exploded drawing of the prior art structure.

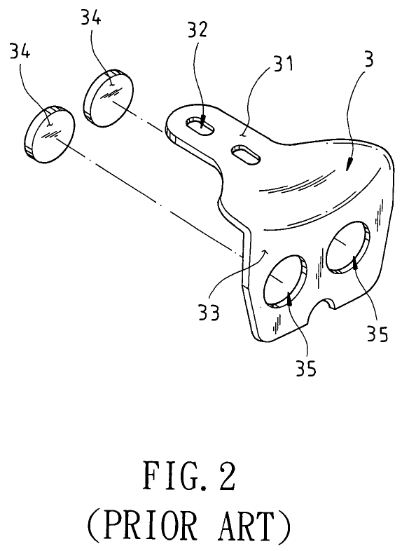

FIG. 3 is a cross-sectional drawing of the structure shown in FIG. 1, as viewed from the perspective of line A-A.

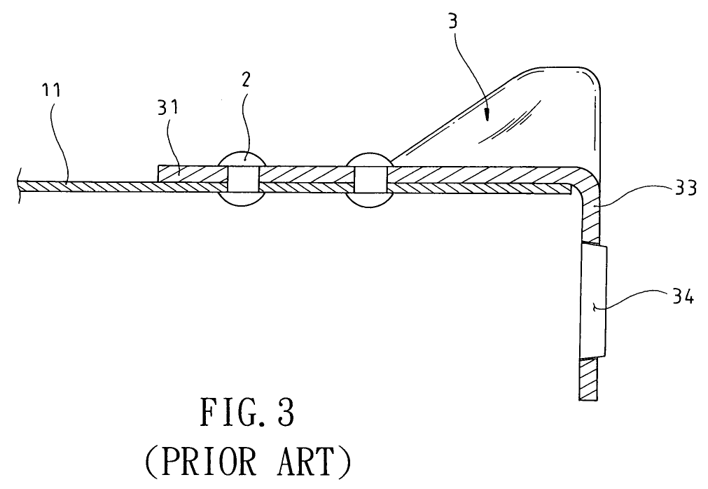

FIG. 4 is an exploded drawing of the structure of the invention herein.

FIG. 5 is an exploded drawing of the structure of the invention herein.

FIG. 6 is a cross-sectional drawing of the structure shown in FIG. 4, as viewed from the perspective of line B-B.

### DETAILED DESCRIPTION OF THE PREFERRED EMBODIMENTS

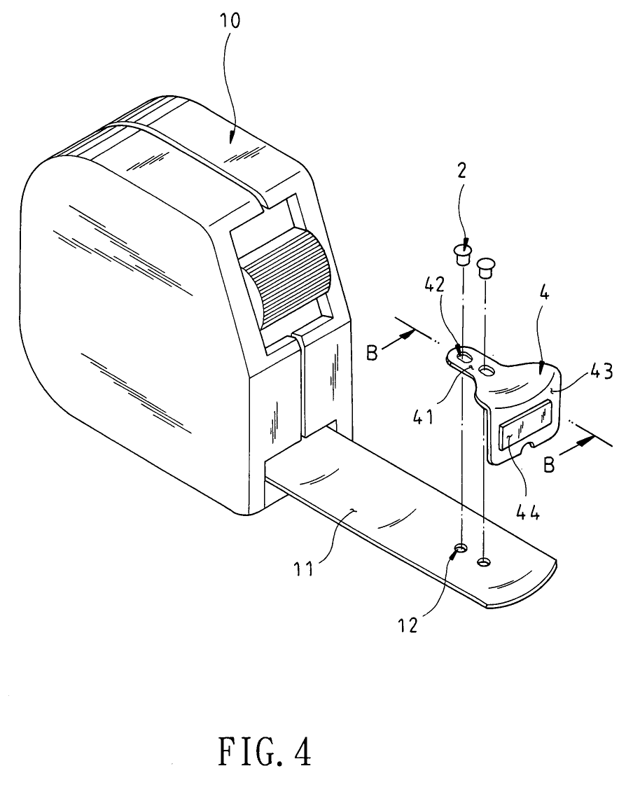

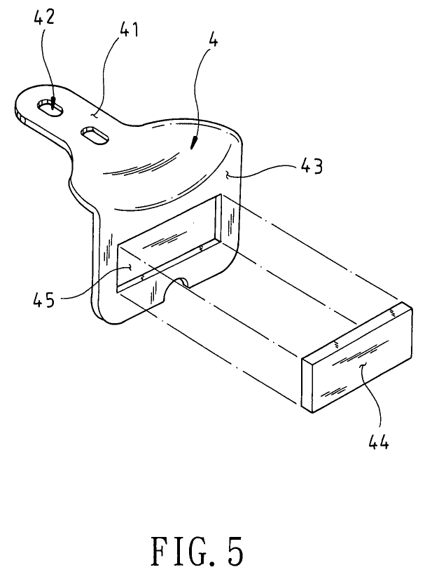

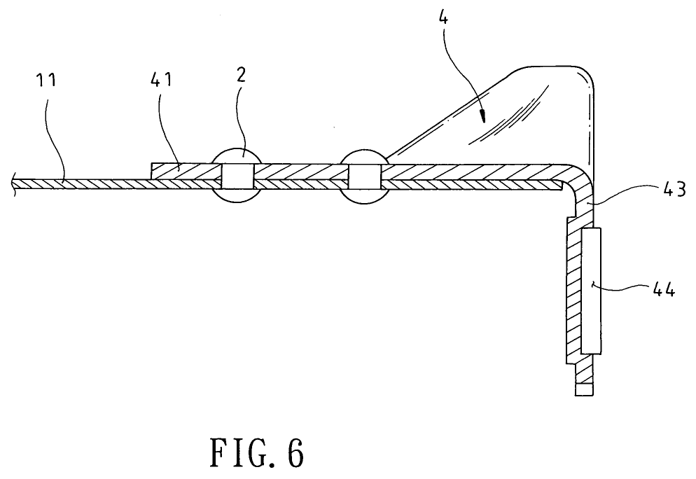

Referring to FIG. 4, FIG. 5, and FIG. 6, the invention herein is an improved structure tape rule hook, the tape rule 10 having disposed at the frontmost extremity of its blade 11 a plurality of round holes 12; additionally, the hook 4 is a planar component bent vertically to thereby form a hook mounting element 41 at its upper extent, and disposed on the hook mounting element 41 are a plurality of elongated round holes 42 and, furthermore, the other side is bent downward vertically to form a hook measuring element 43, said hook measuring element 43 having a containment recess 45, which is die extruded, enabling the embedding of an attractive component 44 that is thereby fixed onto the hook measuring element 43; the hook 4 also consists of a plurality of rivets 2 that are inserted through the elongated round holes 42 of the hook mounting element 41 as well as the round holes 12 of the blade 11 which are then compressively fastened into place, thereby enabling the hook 4 and the blade 11 to become conjoined into a unitary structure.

The invention herein includes the attractive component 44 at the front end of the hook 4, and as such, during the measurement operation process, is capable of becoming drawn to the surface at the starting point of the physical object being measured, the attractive component 44 at the front end of the hook 4 having the capability of being drawn to the surface of the physical object thereby facilitating tape rule measurement operation by a single person or the conducting of the task by using only one hand, which thereby effectively increases its product utility.

In summation of the foregoing section, since the improved structure tape rule hook of the invention herein is definitely capable of achieving the objectives and applications so described and, furthermore, increases product utility and convenience while also providing industrial practical value, the present invention complies with new patent application requirements and is submitted for review and the granting of the commensurate patent rights.

1. An improved structure tape rule hook, said tape rule having disposed at the frontmost extremity of its blade a plurality of round holes; additionally, the hook is a planar component bent vertically to thereby form a hook mounting element at its upper extent, and disposed on said hook mounting element are a plurality of elongated round holes and, furthermore, the other side is bent downward vertically to form a hook measuring element, said hook measuring element having a containment recess, which is die extruded, enabling the embedding of an attractive component that is thereby fixed onto the hook measuring element; said hook also consists of a plurality of rivets that are inserted through the elongated round holes of the hook mounting element as well as the round holes of the blade which are then compressively fastened into place, thereby enabling the hook and the blade to become conjoined into a unitary structure.
